(19) United States
(12) Patent Application Publication
(10) Pub. No.: US 2026/0088880 A1
(43) Pub. Date: Mar. 26, 2026

(54) SCATTER/ABSORPTION MODE FOR RECONFIGURABLE INTELLIGENT SURFACE(RIS)-ASSISTED WIRELESS SYSTEM

(71) Applicant: SAMSUNG ELECTRONICS CO., LTD., Suwon-si, Gyeonggi-do (KR)

(72) Inventors: Mohammed Saquib Noorulhuda KHAN, Bengaluru (IN); Ashok Kumar Reddy CHAVVA, Bengaluru (IN); Anusha GUNTURU, Bengaluru (IN); Ankur GOYAL, Bengaluru (IN); Hari Krishna BODDAPATI, Bengaluru (IN)

(21) Appl. No.: 19/109,952

(22) PCT Filed: Sep. 1, 2023
(86) PCT No.: PCT/KR2023/013107

§ 371 Date: Mar. 7, 2025

(30) Foreign Application Priority Data
Sep. 8, 2022 (IN) 202241051406
Aug. 8, 2023 (IN) 202241051406

(51) Int. Cl. H04B 7/06; H04B 7/04

(52) U.S. Cl. CPC H04B 7/0695; H04B 7/04013

(57) ABSTRACT

The present disclosure relates to a 5G communication system or a 6G communication system for supporting higher data rates beyond a 4G communication system such as long term evolution (LTE). In an embodiment of the disclosure, the method performed by a base station is provided. The method comprises transmitting to an UE a RS for at least one of a direct BS candidate beam and an RIS candidate beam and receiving from the UE a measurement report comprising a RSRP. In case that the RSRP meets the RSRP criteria, the method comprises selecting a first mode configuration for the RIS among a plurality of mode configurations for the RIS based on a link between the BS and the UE. The method comprises switching from the RIS candidate beam to direct BS candidate beam and scattering the multiple beams from the RIS in different directions.

### TECHNICAL FIELD

The present disclosure relates to wireless communication systems, and more particularly to a method and a system for configuring scatter/absorption mode for Reconfigurable Intelligent Surface (RIS)-assisted wireless system.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mm Wave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network per-formances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mecahnisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The principal object of the embodiments herein is to provide a method and a system for configuring scatter/absorption mode for RIS-assisted wireless system. The method includes detecting Reference Signal Received Power (RSRP) of a direct candidate beam and RSRP of a RIS candidate beam in response to receiving a Reference Signal (RS) of the direct candidate beam and a RS of the RIS candidate beam from a BS.

Another object of the embodiments herein is to configure a full absorption/OFF mode to the RIS and perform beam switching for direct BS-UE connection by making the RIS idle, when the RSRP of the direct candidate beam is greater than the RSRP of the RIS candidate beams, or configure an exact configuration mode to the RIS for exact reflection of the RIS candidate beam, when the RSRP of the direct candidate beam is lower than the RSRP of the RIS candidate beams.

The proposed method configures the full absorption/OFF mode to the RIS by: randomly selecting phase shifts and amplitudes of each RIS element of the RIS, and splitting the RIS into a plurality of sub-RISs to transmit multiple beams in different directions, and distributing total power among the plurality of sub-RISs such that the RIS scatters energy in all directions rather than a specific direction.

### Solution to Problem

In an embodiment of the disclosure, the method performed by a base station is provided. The method comprises transmitting, to the UE a reference signal (RS) for at least one of a direct BS candidate beam and a RIS candidate beam. The method further comprises receiving, from the UE, a measurement report comprising a Reference Signal Received Power (RSRP) measured by the UE for at least one of the direct BS candidate beam and the RIS candidate beam. The method further comprises determining whether the RSRP meets a RSRP criteria indicating the RIS is idle. The method further comprises in case that the RSRT meets the RSRP criteria, selecting a first mode configuration for the RIS among a plurality of mode configurations for the RIS based on a link between the BS and the UE, wherein the first mode configuration is configured for scattering the multiple beams from the RIS. And the method further comprises switching from the RIS candidate beam to the direct BS candidate beam and scattering the multiple beams from the RIS in different directions.

In an embodiment of the disclosure, the method performed by RIS controller is provided. The method comprises creating a first mode configuration to scatter the multiple beams from the RIS when the RIS is ide. The method further comprises storing the first mode configuration for the RIS among a plurality of mode configurations for the RIS. And the method further comprises configuring the first mode configuration to the RIS for scattering the multiple beams from the RIS in different directions.

In an embodiment of the disclosure, a bases station for wireless communication is provided. The base station comprises a memory, a processor coupled to the memory, a communicator coupled to the memory and the processor, and a beam scattering controller coupled to the memory, the processor, and the communicator. The processor is configured to transmit, to the UE a reference signal (RS) for at least one of a direct BS candidate beam and a RIS candidate beam. The processor is further configured to receive, from the UE, a measurement report comprising a Reference Signal Received Power (RSRP) measured by the UE for at least one of the direct BS candidate beam and the RIS candidate beam. The processor is further configured to determine whether the RSRP meets a RSRP criteria indicating the RIS is idle. The processor is further configured to, in case that the RSRT meets the RSRP criteria, select a first mode configuration for the RIS among a plurality of mode configurations for the RIS based on a link between the BS and the UE, wherein the first mode configuration is configured for scattering the multiple beams from the RIS. And the processor is further configured to switch from the RIS candidate beam to the direct BS candidate beam and scattering the multiple beams from the RIS in different directions.

These and other aspects of the embodiments herein will be better appreciated and understood when considered in conjunction with the following description and the accompanying drawings. It should be understood, however, that the following de-scriptions, while indicating preferred embodiments and numerous specific details thereof, are given by way of illustration and not of limitation. Many changes and modifications may be made within the scope of the embodiments herein without departing from the disclosure thereof, and the embodiments herein include all such modifications.

### BRIEF DESCRIPTION OF DRAWINGS

These and other features, aspects, and advantages of the present method are illustrated in the accompanying drawings, throughout which like reference letters indicate corresponding parts in the various figures. The embodiments herein will be better understood from the following description with reference to the drawings, in which:

FIG. 1 is an example illustrating a scenario when BS-UE direct link is present between a BS and a UE, according to the prior arts;

FIG. 2 is a graphical view illustrating a relation of phase shift and amplitude, according to the prior arts;

FIG. 3 is an example illustrating RIS configurations, according to the prior arts;

FIG. 4 is a block diagram of an RIS controller of a RIS-assisted wireless system, according to an embodiment of the present disclosure;

FIG. 5 is a block diagram of the BS, according to an embodiment of the present disclosure;

FIG. 6 is a flow chart illustrating a method for configuring scatter/absorption mode for RIS-assisted wireless system, according to an embodiment of the present disclosure;

FIG. 7 is a schematic view of a RIS, according to an embodiment of the present disclosure;

FIG. 8 is an example illustrating the RIS configurations, according to an embodiment of the present disclosure;

FIG. 9 is an example illustrating RIS reflection pattern with random phase shift, according to an embodiment of the present disclosure;

FIG. 10A is an example illustrating the RIS divided into a plurality of sub-RISs, according to an embodiment of the present disclosure;

FIG. 10B is an example illustrating a RIS reflection pattern with RIS elements, according to an embodiment of the present disclosure;

FIG. 11 is a graphical view illustrating comparison of the RIS reflection patterns with random phase shifts and multi-beams, according to an embodiment of the present disclosure;

FIG. 12 is an absorption mode flow diagram, according to an embodiment of the present disclosure; and

FIG. 13 is an example illustrating a step-by-step procedure for configuring scatter/absorption mode for RIS-assisted wireless system, according to an embodiment of the present disclosure.

FIG. 14 is a schematic block diagram illustrating the structure of a base station according to an embodiment of the present disclosure.

FIG. 15 is a schematic block diagram illustrating the structure of an RIS controller according an embodiment of the present disclosure.

### MODE FOR THE INVENTION

The embodiments herein and the various features and advantageous details thereof are explained more fully with reference to the non-limiting embodiments that are illustrated in the accompanying drawings and detailed in the following description. De-scriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

In general, reconfigurable intelligent surface (RIS) is envisaged as an emerging wireless technology for control of radio signals between a transmitter and a receiver in a dynamic and goal-oriented way, turning a wireless environment into a service. The RIS in wireless communications enables network operators to control scattering, reflection, and refraction characteristics of radio waves, by overcoming negative effects of a natural wireless propagation.

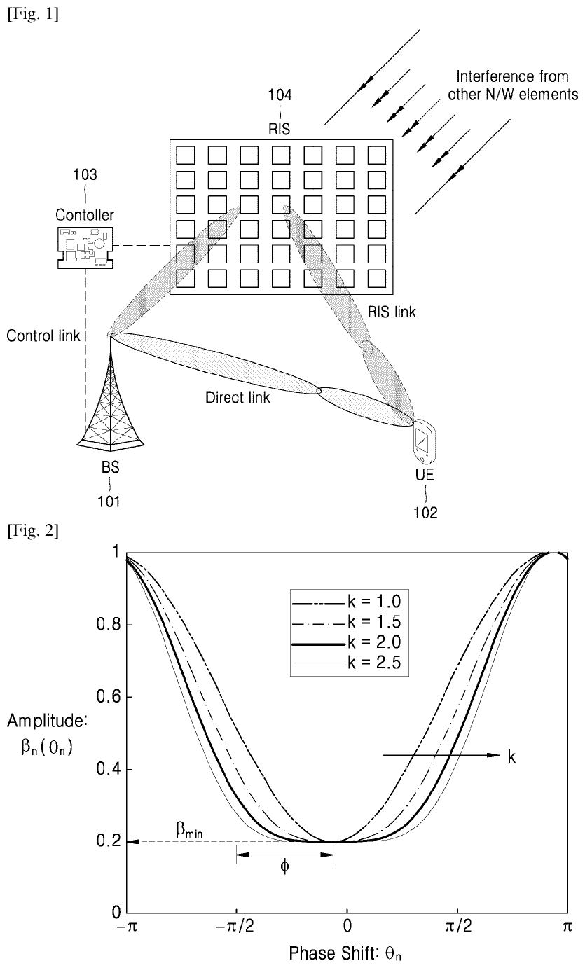

Conventionally, when the RIS (104) is not used in a network, unwanted signals always interfere with a User Equipment (UE) (102) due to minimal reflection amplitudes from a RIS element. Thereby, causing unavoidable interference, for instance, to obtain channel state information of a direct channel (i.e., no blockage) between a Base Station (BS) (101) and the UE (102), as shown in FIG. 1. Numerous interference suppression techniques have been introduced to suppress unwanted reflections from the RIS (104), which requires optimal reflection beamforming or phase shifts, to add signals destructively. But, achieving optimal phase shifts for each RIS element remains an open problem. In a controller (103), different configurations are pre-programmed to have fixed phase shifts and amplitude, and each configuration directs energy in a specific direction, causing interferences to the UE (102).

Thus, it is desired to address the above mentioned disadvantages or other shortcomings or at least provide a useful alternative to select the phase shifts and the amplitudes randomly such that the RIS scatters energy in all direction rather than the specific direction.

Accordingly, the embodiments herein disclose a method for scattering multiple beams from a RIS in different directions in a RIS-assisted wireless system. The method includes creating, by an RIS controller, an OFF mode configuration to scatter the multiple beams from the RIS when the RIS is idle. The OFF mode configuration includes at least one of randomly selected at least one of phase shift and amplitude of each RIS element of a plurality of RISs of the RIS, and a total power of the RIS distributed among a plurality of sub RISs, where each sub-RIS of a plurality of sub-RISs includes at least one RIS element of the plurality of RIS elements of the RIS. The method includes storing, by the RIS controller, the OFF mode configuration for the RIS among a plurality of mode configurations for the RIS in a memory of the RIS controller connected between the BS and the RIS. The method also includes configuring, by the RIS controller, the OFF mode configuration to the RIS for scattering the multiple beams from the RIS in different directions towards the UE.

Accordingly, the embodiments herein disclose the RIS controller for scattering multiple beams from the RIS in different directions in the RIS-assisted wireless system. The RIS controller includes a memory storing a plurality of mode configurations, and a beam scattering circuit coupled to the memory. The beam scattering circuit configured to create the OFF mode configuration to scatter the multiple beams from the RIS when the RIS is idle. The OFF mode configuration includes at least one randomly selected at least one of phase shift and amplitude of each RIS element of a plurality of RISs of the RIS, and a total power of the RIS distributed among a plurality of sub RISs, where each sub-RIS of a plurality of sub-RISs comprises at least one RIS element of the plurality of RIS elements of the RIS. The beam scattering circuit configured to store the OFF mode configuration for the RIS among a plurality of mode configurations for the RIS in the memory of the RIS controller, and configure the OFF mode configuration to the RIS for scattering the multiple beams from the RIS in different directions towards the UE.

In an embodiment, wherein a first mode configuration is at least one of the OFF mode configuration, a scatter mode configuration, an abort mode configuration and an absorption mode configuration.

In an embodiment, the off mode configuration is otherwise referred as at least one of the scatter mode configuration, the abort mode configuration and the absorption mode configuration.

Accordingly, the embodiments herein disclose the BS for scattering multiple beams from the RIS in different directions in the RIS-assisted wireless system. The BS includes a memory, a processor coupled to the memory, a communicator coupled to the memory and the processor, and a beams scattering controller coupled to the memory, the processor and the communicator. The beams scattering controller configured to transmit the RS for at least one of the direct BS candidate beam and the RIS candidate beam to the UE, receive the measurement report comprising the RSRP measured by the UE for at least one of the direct BS candidate beam and the RIS candidate beam from the UE, determine the RSRP meets the RSRP criteria indicating the RIS is idle, select the OFF mode configuration for the RIS when the RSRP meets the RSRP criteria, and switch from the RIS candidate beam to the direct BS candidate beam for scattering the multiple beams from the RIS in different directions towards the UE.

Conventional methods and systems use RIS in communication systems. The conventional methods and systems include a controllable meta-surface device redirecting a wavefront transmitted by a transmitter to a receiver in a wireless network. RIS panel channel measurement configuration information is used to configure the RIS to reflect a Reference Signal (RS) for measurement to a UE. A RIS panel is divided into sub-panels based on configuration information from a BS, where each sub-panel serves a different UE or a set of UEs. Though the conventional methods and systems configure the RIS and divide the RIS panel into the sub-panels based on configuration information from the BS, the conventional methods and systems fail to spread out energy (beam) in all spatial directions to suppress interference.

Conventionally, numerous interference suppression techniques have been introduced to suppress unwanted reflections from the RIS, which requires optimal reflection beamforming or phase shifts, to add the signals destructively. However, achieving the optimal phase shifts for each RIS element remains an open problem.

FIG. 1 is an example illustrating a scenario when BS_UE direct link is present between a BS and a UE, according to the prior arts.

According to the prior arts, when the RIS (104) is not used in a network, unwanted signals always interfere with a User Equipment (UE) (102) due to minimal reflection amplitudes from a RIS element. Thereby, causing unavoidable interference, for instance, to obtain channel state information of a direct channel (i.e., no blockage) between a Base Station (BS) (101) and the UE (102). And the energy with a minimum amplitude is always reflected from the RIS element, causing interference to the users.

FIG. 2 illustrates a relation of the phase shift and the amplitude, according to the prior arts.

According to the prior arts, a reflection coefficient at each RIS element is defined as follows:

$${v}_{n} = {β}_{n} ( {θ}_{n} ) {e}^{j {θ}_{n}} \qquad ( 1 )$$

Where, Phase shift: θₙ∈[−π, π); and

### Reflection Amplitude:

$${β}_{n} ( {θ}_{n} ) = ( 1 - {β}_{min} ) {( \frac{sin ( {θ}_{n} - ϕ ) + 1}{2} )}^{k} + {β}_{min}$$

The above expression is applicable to a variety of semiconductor devices used for implementing the RIS.

In conventional methods and systems, the energy with a minimum amplitude is always reflected from the RIS element, causing interference to the users. In a controller (103) as shown in FIG. 1, different configurations, i∈1, are pre-programmed to have fixed phase shifts and amplitude, and each configuration directs the energy in a specific direction, such that the reflection coefficient is defined as follows:

$${v}_{i} = [ {v}_{i , 0} , {v}_{i , 1} , … , {v}_{i , N - 1} ] = [ {β}_{i , 0} ( {θ}_{i , 0} ) {e}^{j {θ}_{i , 0}} , {β}_{i , 1} ( {θ}_{i , 1} ) {e}^{j {θ}_{i , 1}} , … , {v}_{i , N - 1} ] \qquad ( 2 )$$

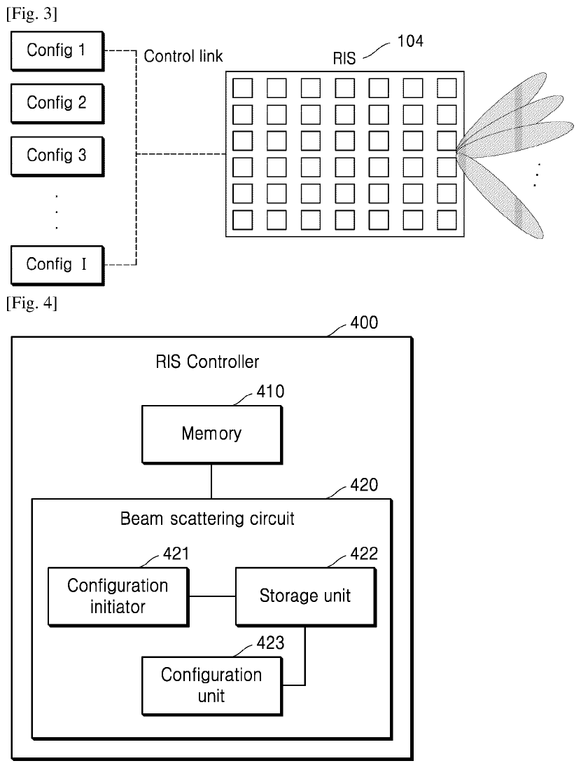

FIG. 3 is an example illustrating the RIS configurations, according to the prior arts. Configuration 1, Configuration 2, Configuration 3, and Configuration I reflect energy (beam) in specific directions, as shown in the FIG. 3. These configurations are fixed as vᵢ. With the conventional configurations, the RIS (104) keeps reflecting with one of the selected configurations, causing the interference to the UE (102).

Since a full absorption mode is impractical, a mode needs to be added to the controller (103) such that the reflection from the RIS (104) would not interfere with the UEs (102).

Unlike the conventional methods and systems, the method according to an embodiment of the present disclosure adds a configuration/mode called as a configuration 0 to disperse signals incident on the RIS in all/different directions. In the configuration 0, the phase shift of each RIS element is randomly configured, which in turn scatters energy in all/different directions by making the unwanted signals significantly less disruptive to the UEs. In the configuration 0, the phase shifts and amplitude of each RIS element of the RIS may be randomly selected. Further in the configuration 0, the RIS may be divided into multiple sub-RISs to transmit multiple beams in different directions, and total power may be distributed among the multiple sub-RISs to disperse the signals incident on the RIS in all/different directions.

Referring now to the drawings and more particularly to FIGS. 4 through 13, where similar reference characters denote corresponding features consistently throughout the figure, these are shown preferred embodiments.

FIG. 4 is a block diagram of an RIS controller (400) of a RIS-assisted wireless system, according to an embodiment of the present disclosure.

In an embodiment, the RIS controller (400) includes a memory (410) and a beam scattering circuit (420).

The memory (410) is configured to store a plurality of configuration modes for an RIS.

In an embodiment, the beam scattering circuit (420) includes a configuration initiator (421), a storing unit (422) and a configuration unit (423).

In an embodiment, the configuration initiator (421) creates an OFF mode configuration to scatter multiple beams from the RIS when the RIS is idle. The OFF mode configuration includes phase shift and amplitude of each RIS element of a plurality of RISs of the RIS. Phase shift and amplitude of each RIS element of a plurality of RISs of the RIS may be randomly selected. The OFF mode configuration includes a total power of the RIS distributed among a plurality of sub RISs. Each sub-RIS of a plurality of sub-RISs includes at least one RIS element of the plurality of RIS elements of the RIS.

In an embodiment, the storing unit (422) stores the created OFF mode configuration for the RIS among a plurality of mode configurations for the RIS in the memory (410) of the RIS controller (400). The RIS controller (400) is connected between a BS and the RIS.

In an embodiment, the configuration unit (423) configures the OFF mode configuration to the RIS for scattering the multiple beams from the RIS in different directions towards the UE.

FIG. 5 is a block diagram of the BS (500), according to an embodiment of the present disclosure. Referring to the FIG. 5, the BS (500) includes a memory (510), a processor (520), a communicator (530), and a beam scattering controller (540).

The memory (510) is configured to store different configuration modes to be executed by the processor (520). The memory (510) includes non-volatile storage elements. Examples of such non-volatile storage elements include magnetic hard discs, optical discs, floppy discs, flash memories, or forms of electrically programmable memories (EPROM) or electrically erasable and programmable (EEPROM) memories. In addition, the memory (510), in some examples, is considered a non-transitory storage medium. The term “non-transitory” indicates that the storage medium is not embodied in a carrier wave or a propagated signal. However, the term “non-transitory” is not interpreted that the memory (510) is non-movable. In some examples, the memory (510) is configured to store larger amounts of information. In certain examples, a non-transitory storage medium stores data that changes over time (e.g., in Random Access Memory (RAM) or cache).

The processor (520) includes one or a plurality of processors. The one or the plurality of processors (520) is a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (520) includes multiple cores and is configured to identify the configuration modes stored in the memory (510).

In an embodiment, the communicator (530) includes an electronic circuit specific to a standard that enables wired or wireless communication. The communicator (530) is configured to communicate internally between internal hardware components of the BS (500) and with external devices via one or more networks.

In an embodiment, the beam scattering controller (540) includes a transmitter (541), a receiver (542), a RSRP determination unit (543), and a beam switching unit (544).

In an embodiment, the transmitter (541) is configured to transmit a Reference Signal (RS) for a direct candidate beam and a RIS candidate beam periodically to a UE. The BS (500) is connected to the UE through the RIS with at least one mode configuration of a plurality of mode configurations, for example a configuration i. Before sending the RS on the RIS candidate beam, the transmitter (541) sends correct configuration mode to the RIS for correct reflections.

The UE measures a Reference Signal Received Power (RSRP) for the direct candidate beam and the RIS candidate beam upon receiving the RS for the direct candidate beam and the RIS candidate beam from the BS (500).

In an embodiment, the receiver (542) is configured to receive a measurement report on the RSRP of the direct candidate beam and the RIS candidate beam from the UE. The measurement report includes a Measure-Configuration Information Element (IE) having the RSRP for at least one of the direct BS candidate beam and the RIS candidate beam.

In an embodiment, the RSRP determination unit (543) is configured to determine whether the RSRP meets a RSRP criteria indicating the RIS is idle. The RSRP criteria is determined based on a position of the UE, the measurement report received from the UE, a position of the RIS, a nature of beam blockage and predefined threshold values.

In an embodiment, the RSRP determination unit (543) is configured to determine whether the RSRP of the direct candidate beam is greater than or lesser than the RSRP of the RIS candidate beams based on the measurement report received from the UE.

In an embodiment, the beam switching unit (544) is configured to select the OFF mode configuration for the RIS when the RSRP meets the RSRP criteria. Further, the beam switching unit (544) switches from the RIS candidate beam to the direct BS candidate beam and scatters the multiple beams from the RIS in different directions towards the UE.

In an embodiment, the beam switching unit (544) is configured to select and configure the OFF mode configuration to the RIS and make the RIS idle, when the RSRP of the direct candidate beam is greater than the RSRP of the RIS candidate beam. Further, the beam switching unit (544) switches from the RIS candidate beam to the direct BS candidate beam and scatters the multiple beams from the RIS in different directions towards the UE.

In an embodiment, the beam switching unit (544) configures the at least one mode configuration from the plurality of mode configuration to the RIS for reflection of the RIS candidate beam, when the RSRP of the direct candidate beam is lower than the RSRP of the RIS candidate beams.

The beam scattering controller (540) is implemented by processing circuitry such as logic gates, integrated circuits, microprocessors, microcontrollers, memory circuits, passive electronic components, active electronic components, optical components, hardwired circuits, or the like, and optionally driven by a firmware. The circuits, for example, are embodied in one or more semiconductor chips, or on substrate supports such as printed circuit boards and the like.

At least one of the plurality of modules/components of beam scattering controller (540) is implemented through an AI model. A function associated with the AI model is performed through the memory (510) and the processor (520). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired char-acteristic is made. The learning is performed in a device itself in which AI according to an embodiment is performed, and/or implemented through a separate server/system.

The AI model consists of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Although the FIG. 4 and FIG. 5 show the hardware elements of the RIS controller (400) and the BS (500) but it is to be understood that other embodiments are not limited thereon. In other embodiments, the RIS controller (400) and the BS (500) include less or more number of elements. Further, the labels or names of the elements are used only for illustrative purpose and does not limit the scope of the disclosure. One or more components are combined together to perform same or substantially similar function.

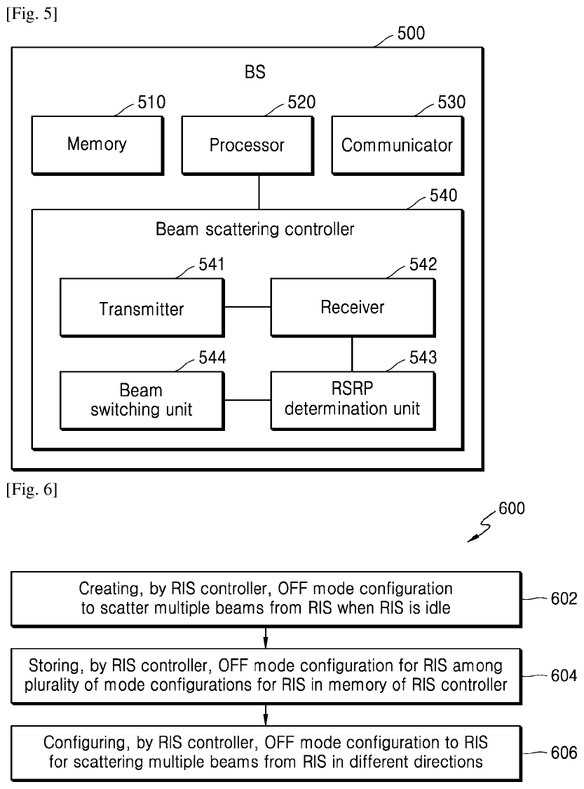

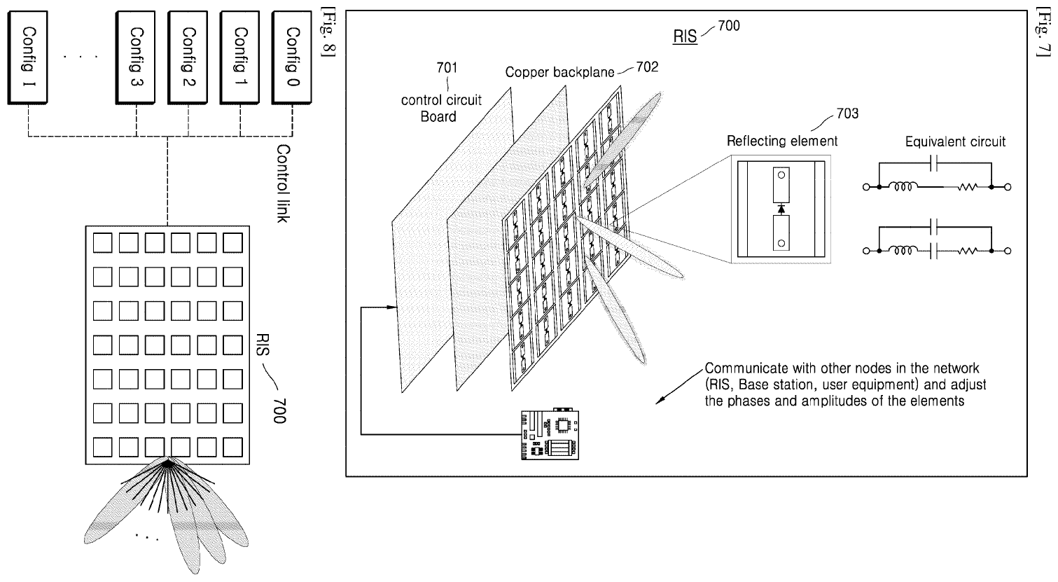

FIG. 6 is a flow chart (600) illustrating a method for configuring scatter/absorption mode for RIS-assisted wireless system, according to an embodiment of the present disclosure.

Referring to the FIG. 6, at step 602, the method includes the RIS controller (400) creating the OFF mode configuration to scatter the multiple beams from the RIS when the RIS is idle. For example, in the RIS controller (400) as illustrated in the FIG. 4, the beam scattering circuit (420) is configured to create the OFF mode configuration to scatter the multiple beams from the RIS when the RIS is idle.

At step 604, the method includes the RIS controller (400) storing the OFF mode configuration for the RIS among the plurality of mode configurations for the RIS in the memory (410) of the RIS controller connected between the BS (500) and the RIS. For example, in the RIS controller (400) as illustrated in the FIG. 4, the beam scattering circuit (420) is configured to store the OFF mode configuration for the RIS among the plurality of mode configurations for the RIS in the memory (410) of the RIS controller connected between the BS (500) and the RIS.

At step 606, the method includes the RIS controller (400) configuring the OFF mode configuration to the RIS for scattering the multiple beams from the RIS in different directions. For example, in the RIS controller (400) as illustrated in the FIG. 4, the beam scattering circuit (420) configures the OFF mode configuration to the RIS for scattering the multiple beams from the RIS in different directions.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

FIG. 7 is a schematic view of a RIS (700), according to an embodiment of the present disclosure.

Referring to the FIG. 7, the RIS (700) is connected to the RIS controller (400). The RIS (700) includes a control circuit board (701), a copper backplane (702) and a plurality of reflecting elements.

The control circuit board (701) such as for example but not limited to a Printed Circuit Board (PCB), a Printed Wiring Board (PWB) acts as a medium to connect electronic components to one another in a controlled manner.

The copper backplane (702) is used as a support structure for connecting a plurality of control circuit boards (701). The plurality of reflecting elements are configured to reflect multiple beams into the different directions.

In an embodiment, the RIS controller (400) communicates with other nodes in the RIS-assisted wireless system including the RIS (700), the BS (500) and the UE. The RIS controller (400) adjusts the phase shift and the amplitude of the at least one RIS element for example the reflecting element (703) of the plurality of RIS elements of the RIS (700) based on the OFF mode configuration, when the OFF mode configuration includes randomly selected at least one of the phase shift and the amplitude of each reflecting element (703). Further, the RIS controller (400) assists the RIS (700) to scatter the multiple beams into the different directions throughout the RIS-assisted wireless system based on the adjusted phase shifts and the amplitudes of the reflecting element (703).

In an embodiment, the RIS controller (400) divides the RIS (700) into the plurality of sub-RISs based on the OFF mode configuration, when the OFF mode configuration includes the total power of the RIS (700) distributed among the plurality of the sub-RISs. The RIS controller (400) allocates the total power of the RIS (700) among the plurality of sub-RISs based on the OFF mode configuration, and assists the RIS (700) to scatter the multiple beams into the different directions throughout the RIS-assisted wireless system from each sub-RIS of the plurality of sub-RISs.

The RIS (700) is a digitally-controlled Meta surface with massive low-cost passive reflecting element (703) (each able to induce an amplitude/phase change in the incident signal). Using the RIS (700), low energy consumption is ensured without use of any transmit Radio Frequency (RF) chains, and high spectral efficiency (full-duplex, noiseless reflection) is achieved.

The RIS (700) is utilised for coverage enhancement to areas of lower or no signal strength, for example a cell edge with appropriate reflection directions.

FIG. 8 is an example illustrating the RIS configurations, according to an embodiment of the present disclosure.

Referring to FIG. 8, the method according to an embodiment of the present disclosure adds the OFF mode configuration such as for example the configuration 0 to select the phase shifts and amplitudes at the RIS (700) such that the RIS (700) scatters energy in all and/or different directions rather than a specific direction. Adding the configuration 0 to the RIS (700) causes the phase shift of each reflecting element (703) to be selected randomly. With the additional configuration 0, the energy is scattered in all the directions rather than the specific direction to suppress an interference from other network elements. The configuration 0 is used when the RIS (700) is not required in the RIS-assisted wireless system.

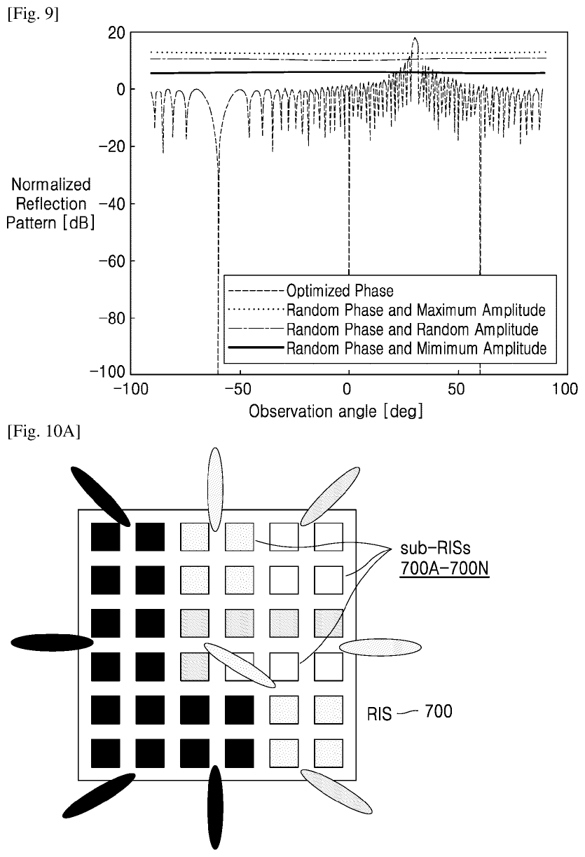

FIG. 9 is an example illustrating a RIS reflection pattern with random phase shift, according to an embodiment of the present disclosure.

With the configuration 0, the phase shifts and the amplitude are selected randomly.

FIG. 9 shows the RIS radiation pattern when:

Optimized Phase: Incident and reflective angles are fixed and the phase shifts at the RIS (700) are optimized to reflect in a reflective angle direction.

Random Phase: The phase shifts of each element at the RIS (700) are selected randomly from (0,2π] and the amplitude is one.

Random Phase and Random Amplitude: The phase shifts and the amplitudes of each element at the RIS (700) are selected randomly from (0,2π) and {0.2,0.3, . . . ,1}, re-spectively.

Random Phase and Minimum Amplitude: The phase shifts of each element at the RIS (700) are selected randomly from (0,2π] and the amplitude of each element is 0.2.

Where, the number of the RIS element is 64, an angle of incidence is 0° and an angle of reflection is 30°.

Comparatively, the random phase and minimum amplitude provides best absorption with a difference of 12 dB as compared to the optimized phase.

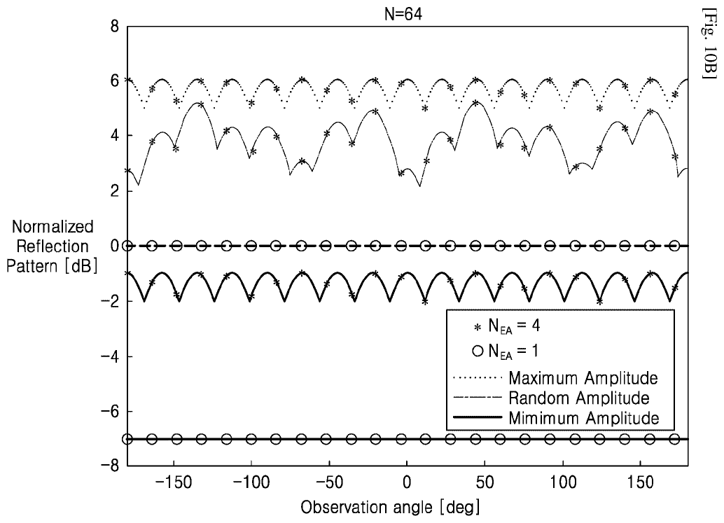

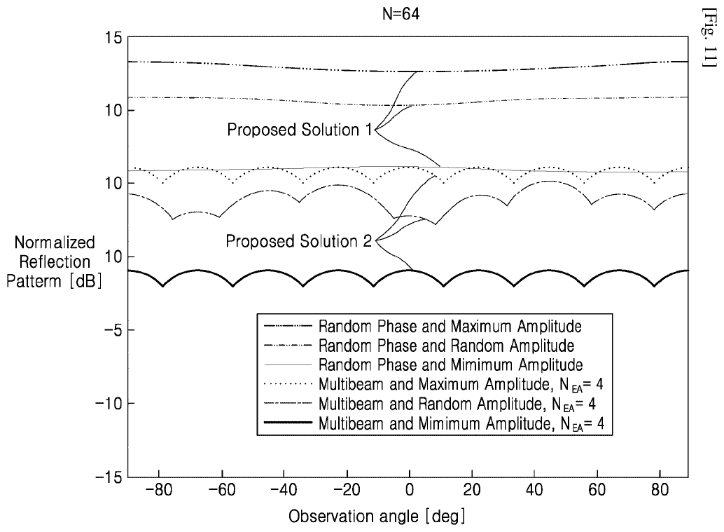

FIG. 10A is an example illustrating the RIS (700) divided into the plurality of sub-RISs (700A-700N), according to an embodiment of the present disclosure.

Referring to FIG. 10A, with the configuration 0, the whole RIS (700) is divided into the plurality of sub-RISs (700A-700N), for example NA sub-RISs. Each sub-RIS of the plurality of sub-RISs (700A-700N) includes at least one reflecting element (703), for example NEA element. By dividing the RIS (700) to the plurality of sub-RISs (700A-700N), the multiple beams are transmitted to different directions and the total power is distributed among the plurality of sub-RISs (700A-700N).

As the RIS (700) is divided into the plurality of sub-RISs (700A-700N), the RIS (700) transmits multiple NA beams simultaneously. Here, NA=N/NEA and the re-spective directions of reflection is selected such as [−180: 360/NA: 180-360/NA].

FIG. 10B is an example illustrating a RIS reflection pattern with the reflecting element (703), according to an embodiment of the present disclosure.

Referring to FIG. 10B, the RIS (700) is divided into the plurality of sub-RISs (700A-700N) to provide an element level freedom for signal reflection to the whole RIS-assisted wireless system and provide the best absorption with minimum amplitude and NEA=1 to achieve a difference of 25 dB as compared to the optimized phase.

FIG. 11 is a graphical view illustrating comparison of the RIS reflection patterns with random phase shifts and the multiple beams, according to an embodiment of the present disclosure.

Referring to FIG. 11, the reflection pattern obtained by dividing the RIS (700) into the plurality of sub-RISs (700A-700N) provides lesser beam gain than the reflection pattern obtained by randomly selecting the phase shifts and the amplitude of the RIS (700), because of the fact that only the NEA elements are used to form the beam in the at least one sub-RIS of the plurality of sub-RISs (700A-700N). During random selection of the phase shifts and the amplitude of the RIS (700), all the NEA elements are used to scatter the energy and some of the energy gets added constructively due to the random phase shifts.

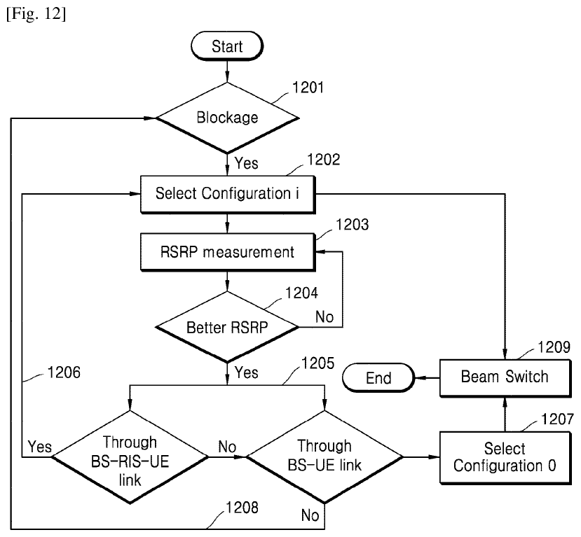

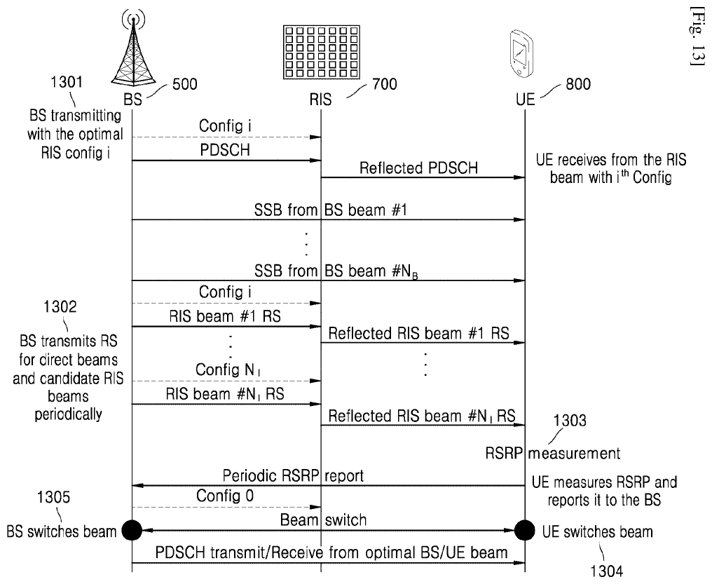

FIG. 12 is an absorption mode flow diagram, according to an embodiment of the present disclosure.

Referring to FIG. 12, at step 1201, the BS (500) determines whether there is a blockage of the RS while transmitting the RS for the direct BS candidate beam to the UE. The beam blockage occurs due to an obstruction such as for example but not limited to topography or tall buildings.

At step 1202, when the BS (500) determines that there is the blockage of the RS while transmitting the RS for the direct BS candidate beam to the UE, the BS (500) selects at least one mode configuration from the plurality of mode configurations configured for the RIS (700). The plurality of mode configurations configured for the RIS (700) includes but not limited to configuration 1, configuration 2, configuration 3, configuration 4, etc.

At step 1203, the UE measures the RSRP for the direct BS candidate beam upon receiving the RS for the direct BS candidate beam from the BS (500) and the RSRP for the RIS candidate beam upon receiving the RS for the RIS candidate beam.

At step 1204, the BS (500) receives the measurement report on the RSRP of the direct BS candidate beam from the UE and the RIS candidate beam and determines whether the RSRP of the direct BS candidate beam meets the RSRP criteria. The measurement report includes a RIS-RSRP element along with a plurality of elements in a Measure-Configuration Information Element (IE).

The RSRP criteria is determined based on the position of the UE, the measurement report received from the UE, a position of the RIS (700), the nature of beam blockage and predefined threshold values.

At step 1205, when the RSRP of the direct BS candidate beam meets the RSRP criteria, the BS (500) determines whether the RS is transmitted to the UE through the BS-RIS-UE link or the BS-UE link based on the RSRP criteria.

At step 1206, when the BS (500) determines that the RS for the direct BS candidate beam is transmitted to the UE through the BS-RIS-UE link, the BS (500) selects the at least one mode configuration of the plurality of mode configurations configured for the RIS (700).

At step 1207, when the BS (500) determines that the RS for the direct BS candidate beam is not transmitted to the UE through the BS-RIS-UE link and is transmitted to the UE through the BS-UE link, the BS (500) selects the OFF mode configuration for the RIS (700). The BS (500) selects the OFF mode configuration for the RIS (700) when the RIS (700) is idle.

At step 1208, when the BS (500) determines that the RS for the direct BS candidate beam is not transmitted to the UE through the BS-RIS-UE link and is not transmitted to the UE through the BS-UE link, the BS (500) again determines whether there is the blockage of the RS while transmitting the RS for the direct candidate BS beam to the UE.

At step 1209, when the at least one mode configuration is selected among the plurality of mode configurations for the RIS (700), transmission of the direct BS candidate beam to the UE is switched from the BS-UE link to the BS-RIS-UE link. Also, when the OFF mode configuration for the RIS (700) is selected, the transmission of the direct BS candidate beam to the UE is switched from the BS-RIS-UE link to the BS-UE link.

FIG. 13 is an example illustrating a step-by-step procedure for configuring scatter/absorption mode for the RIS-assisted wireless system, according to an embodiment of the present disclosure.

Referring to FIG. 13, at step 1301, the UE (800) is connected to the BS (500) via the RIS (700) with the at least one mode configuration i.e., configuration i. Configuration i is identified by sending the RS and getting UE feedback for different RIS beams.

At step 1302, the BS (500) transmits, to the UE (800), the RS for the direct BS candidate beam and the RIS candidate beam periodically. Before sending the RS on the RIS candidate beam, the BS (500) sends correct configuration mode to the RIS (700) for correct reflections.

At step 1303, the UE (800) measures the RSRP from the direct BS candidate beam and the RIS candidate beam, and sends the report to the BS (500). In an embodiment, the measurement report comprises RSRP for the direct BS candidate beam and the RIS candidate beam. The measurement report comprises Measure-Configuration Information Element having the RSRP for the direct BS candidate beam and the RIS candidate beam. The Measure-Configuration Information Element may include a new element for RIS-RSRP as below:

TABLE 1

MeasConfig ::= SEQUENCE {
...
s-MeasureConfig CHOICE {
ssb-RSRP RSRP-Range,
csi-RSRP RSRP-Range,
ris-RSRP RSRP-Range
}
...
}

At step 1304, when the RSRP of the direct BS candidate beam is greater than the RSRP of the RIS candidate beam, the BS (500) configures the OFF mode to the RIS (700) and makes the RIS (700) idle. In addition, the BS (500) switches the beam for direct BS-UE connection.

At step 1305, when the RSRP of the direct BS candidate beam is lesser than the RSRP of the RIS candidate beam, the BS (500) checks the RSRPs of the RIS candidate beam and configures the correct configuration mode to the RIS (700) for correct reflection.

When the RIS (700) is not required by the BS (500), the multiple beams always reflect in the specific direction with one of the plurality of mode configurations configured for the RIS (700), which makes it more susceptible to information leakage to an eavesdropper. The eavesdropper leads to deletion or modification of data that is transmitted between two devices. By configuring the OFF mode configuration to the RIS (700), the information leakage to the eavesdroppers is significantly reduced.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

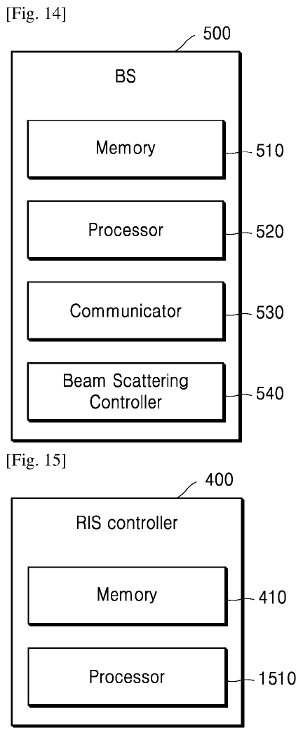

FIG. 14 is a schematic block diagram illustrating the structure of a base station according to an embodiment of the present disclosure. Referring to the FIG. 14, the BS (500) includes a memory (510), a processor (520), a communicator (530), and a beam scattering controller (540).

The memory (510) is configured to store different configuration modes to be executed by the processor (520). The memory (510) includes non-volatile storage elements. Examples of such non-volatile storage elements include magnetic hard discs, optical discs, floppy discs, flash memories, or forms of electrically programmable memories (EPROM) or electrically erasable and programmable (EEPROM) memories. In addition, the memory (510), in some examples, is considered a non-transitory storage medium. The term “non-transitory” indicates that the storage medium is not embodied in a carrier wave or a propagated signal. However, the term “non-transitory” is not interpreted that the memory (510) is non-movable. In some examples, the memory (510) is configured to store larger amounts of information. In certain examples, a non-transitory storage medium stores data that changes over time (e.g., in Random Access Memory (RAM) or cache).

The processor (520) includes one or a plurality of processors. The one or the plurality of processors (520) is a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (520) includes multiple cores and is configured to identify the configuration modes stored in the memory (510).

In an embodiment, the communicator (530) includes an electronic circuit specific to a standard that enables wired or wireless communication. The communicator (530) is configured to communicate internally between internal hardware components of the BS (500) and with external devices via one or more networks.

In an embodiment, the beam scattering controller (540) includes a transmitter, a receiver, a RSRP determination unit, and a beam switching unit.

The beam scattering controller (540) is implemented by processing circuitry such as logic gates, integrated circuits, microprocessors, microcontrollers, memory circuits, passive electronic components, active electronic components, optical components, hardwired circuits, or the like, and optionally driven by a firmware. The circuits, for example, are embodied in one or more semiconductor chips, or on substrate supports such as printed circuit boards and the like.

At least one of the plurality of modules/components of beam scattering controller (540) is implemented through an AI model. A function associated with the AI model is performed through the memory (510) and the processor (520). The one or a plurality of processors controls the processing of the input data in accordance with a predefined operating rule or the AI model stored in the non-volatile memory and the volatile memory. The predefined operating rule or artificial intelligence model is provided through training or learning.

Although the FIG. 5 and FIG. 14 show the hardware elements of the BS (500) but it is to be understood that other embodiments are not limited thereon. In other embodiments, the BS (500) include less or more number of elements. Further, the labels or names of the elements are used only for illustrative purpose and does not limit the scope of the disclosure. One or more components are combined together to perform same or substantially similar function.

FIG. 15 is a schematic block diagram illustrating structure of an RIS controller according to an embodiment of the present disclosure. Referring to the FIG. 15, the RIS controller (400) includes a memory (410), and a processor (1510).

In an embodiment, the processor (1510) includes configuration initiator, and a configuration unit.

In an embodiment, the processor (1510) creates an OFF mode configuration to scatter multiple beams from the RIS when the RIS is idle. The OFF mode configuration includes phase shift and amplitude of each RIS element of a plurality of RISs of the RIS. Phase shift and amplitude of each RIS element of a plurality of RISs of the RIS may be randomly selected. The OFF mode configuration includes a total power of the RIS distributed among a plurality of sub RISs. Each sub-RIS of a plurality of sub-RISs includes at least one RIS element of the plurality of RIS elements of the RIS.

In an embodiment, the memory (410) stores the created OFF mode configuration for the RIS among a plurality of mode configurations for the RIS in the memory of the RIS controller (400). The RIS controller (400) is connected between a BS and the RIS.

In an embodiment, the processor (1510) configures the OFF mode configuration to the RIS for scattering the multiple beams from the RIS in different directions towards the UE.

Accordingly the embodiments herein disclose a method for scattering multiple beams from a RIS in different directions in a RIS-assisted wireless system. The method includes creating, by an RIS controller, an OFF mode configuration to scatter the multiple beams from the RIS when the RIS is idle. The OFF mode configuration includes at least one of randomly selected at least one of phase shift and amplitude of each RIS element of a plurality of RISs of the RIS, and a total power of the RIS distributed among a plurality of sub RISs, where each sub-RIS of a plurality of sub-RISs includes at least one RIS element of the plurality of RIS elements of the RIS. The method includes storing, by the RIS controller, the OFF mode configuration for the RIS among a plurality of mode configurations for the RIS in a memory of the RIS controller connected between the BS and the RIS. The method also includes configuring, by the RIS controller, the OFF mode configuration to the RIS for scattering the multiple beams from the RIS in different directions towards the UE.

In an embodiment, configuring the OFF mode configuration to the RIS includes transmitting, by the BS, a Reference Signal (RS) for at least one of a direct BS candidate beam and a RIS candidate beam to the UE. The method includes receiving, by the BS, a measurement report including a Reference Signal Received Power (RSRP) measured by the UE for at least one of the direct BS candidate beam and the RIS candidate beam from the UE. The method includes determining, by the BS, the RSRP meets a RSRP criteria indicating the RIS is idle. Further, the method includes selecting, by the BS, the OFF mode configuration for the RIS when the RSRP meets the RSRP criteria, and switching from the RIS candidate beam to the direct BS candidate beam for scattering the multiple beams from the RIS in different directions towards the UE.

In an embodiment, the measurement report includes a Measure-Configuration Information Element (IE) having the RSRP for at least one of the direct BS candidate beam and the RIS candidate beam.

In an embodiment, the method includes determining the RSRP criteria based on at least one of a position of the UE, the measurement report received from the UE, a position of the RIS, a nature of beam blockage and a predefined threshold values of the RSRP.

In an embodiment, selecting, by the BS, the OFF mode configuration for the RIS when the RSRP meets the RSRP criteria includes determining, by the BS, whether the RS is transmitted to the UE through one of a BS-RIS-UE link and a BS-UE link when the RSRP meets the RSRP criteria. The method includes performing, by the BS, one of: selecting another mode configuration from the plurality of mode configurations for the RIS when the RS is transmitted to the UE through the BS-RIS-UE link and sending a RS for the at least one direct BS candidate beam and the RIS candidate beam to the UE using the another mode configuration, and selecting the OFF mode configuration for the RIS when the RS is transmitted to the UE through the BS-UE link.

In an embodiment, wherein a first mode configuration is at least one of the OFF mode configuration, a scatter mode configuration, an abort mode configuration and an absorption mode configuration.

In an embodiment, the off mode configuration is otherwise referred as at least one of the scatter mode configuration, the abort mode configuration and the absorption mode configuration.

In an embodiment, when the OFF mode configuration includes randomly selected at least one of the phase shift and the amplitude of each RIS element of the plurality of RISs, the method includes adjusting, by the RIS controller, at least one of the phase shift and the amplitude of the at least one RIS element of the plurality of RIS elements of the RIS based on the OFF mode configuration, and scattering, by the RIS, the multiple beams into the different directions throughout the RIS-assisted wireless system based on at least one of the adjusted phase shifts and the amplitudes of the least one RIS element.

In an embodiment, when the OFF mode configuration comprises the total power of the RIS distributed among the plurality of the sub-RISs, the method includes dividing, by the RIS controller, the RIS into the plurality of sub-RISs based on the OFF mode configuration, allocating, by the RIS controller, the total power of the RIS among the plurality of sub-RISs based on the OFF mode configuration, and scattering, by the RIS, the multiple beams into the different directions throughout the RIS-assisted wireless system from each sub-RIS of the plurality of sub-RISs.

Accordingly the embodiments herein disclose an RIS controller for scattering multiple beams from the RIS in different directions in the RIS-assisted wireless system. The RIS controller includes a memory storing a plurality of mode configurations, and a beam scattering circuit coupled to the memory. The beam scattering circuit configured to create the OFF mode configuration to scatter the multiple beams from the RIS when the RIS is idle. The OFF mode configuration includes at least one randomly selected at least one of phase shift and amplitude of each RIS element of a plurality of RISs of the RIS, and a total power of the RIS distributed among a plurality of sub RISs, where each sub-RIS of a plurality of sub-RISs comprises at least one RIS element of the plurality of RIS elements of the RIS. The beam scattering circuit configured to store the OFF mode configuration for the RIS among a plurality of mode configurations for the RIS in the memory of the RIS controller, and configure the OFF mode configuration to the RIS for scattering the multiple beams from the RIS in different directions towards the UE.

Accordingly the embodiments herein disclose the BS for scattering multiple beams from the RIS in different directions in the RIS-assisted wireless system. The BS includes a memory, a processor coupled to the memory, a communicator coupled to the memory and the processor, and a beams scattering controller coupled to the memory, the processor and the communicator. The beams scattering controller configured to transmit the RS for at least one of the direct BS candidate beam and the RIS candidate beam to the UE, receive the measurement report comprising the RSRP measured by the UE for at least one of the direct BS candidate beam and the RIS candidate beam from the UE, determine the RSRP meets the RSRP criteria indicating the RIS is idle, select the OFF mode configuration for the RIS when the RSRP meets the RSRP criteria, and switch from the RIS candidate beam to the direct BS candidate beam for scattering the multiple beams from the RIS in different directions towards the UE.

Accordingly the embodiments herein disclose the RIS-assisted wireless system. The RIS-assisted wireless system includes a plurality of UEs, the RIS having the plurality of RIS elements, the RIS controller and the BS. The RIS scatters multiple beams in different directions toward at least one UE of the plurality of UEs. The RIS controller connected to the RIS and configured to create the OFF mode configuration to scatter the multiple beams from the RIS when the RIS is idle. The OFF mode configuration includes at least one randomly selected at least one of phase shift and amplitude of each RIS element of a plurality of RISs of the RIS, and a total power of the RIS distributed among a plurality of sub RISs, where each sub-RIS of a plurality of sub-RISs comprises at least one RIS element of the plurality of RIS elements of the RIS. The beam scattering circuit configured to store the OFF mode configuration for the RIS among a plurality of mode configurations for the RIS in the memory of the RIS controller, and configure the OFF mode configuration to the RIS for scattering the multiple beams from the RIS indifferent directions. The BS is connected to the RIS and the at least one UE of the plurality of UEs through one of the BS-RIS-UE link and the BS-UE link. The BS is configured to transmit the RS for at least one of the direct BS candidate beam and the RIS candidate beam to the UE, receive the measurement report comprising the RSRP measured by the UE for at least one of the direct BS candidate beam and the RIS candidate beam from the UE, determine the RSRP meets the RSRP criteria indicating the RIS is idle, select the OFF mode configuration for the RIS when the RSRP meets the RSRP criteria, and switch from the RIS candidate beam to the direct BS candidate beam for scattering the multiple beams from the RIS in different directions towards the UE. The RIS controller assists the RIS to perform one of: scatter the multiple beams into the different directions throughout the RIS-assisted wireless system by adjusting at least one of the phase shifts and the amplitudes of the least one RIS element, and scatter the multiple beams into the different directions throughout the RIS-assisted wireless system from each sub-RIS of the plurality of sub-RISs by allocating the total power of the RIS among the plurality of sub-RISs based on the OFF mode configuration.

In an embodiment of the disclosure, the method performed by a base station is provided. The method comprises transmitting, to the UE a reference signal (RS) for at least one of a direct BS candidate beam and a RIS candidate beam. The method further comprises receiving, from the UE, a measurement report comprising a Reference Signal Received Power (RSRP) measured by the UE for at least one of the direct BS candidate beam and the RIS candidate beam. The method further comprises determining whether the RSRP meets a RSRP criteria indicating the RIS is idle. The method further comprises in case that the RSRT meets the RSRP criteria, selecting a first mode configuration for the RIS among a plurality of mode configurations for the RIS based on a link between the BS and the UE, wherein the first mode configuration is configured for scattering the multiple beams from the RIS. And the method further comprises switching from the RIS candidate beam to the direct BS candidate beam and scattering the multiple beams from the RIS in different directions.

In an embodiment of the disclosure, the first mode configuration comprises at least one of an OFF mode configuration, scatter mode configuration, abort mode configuration, or absorption mode configuration.

In an embodiment of the disclosure, the first mode configuration comprises randomly selected at least one of phase shift and amplitude of each RIS element of a plurality of RIS element of the RIS. And the first mode configuration comprises a total power of the RIS distributed among a plurality of sub-RISs, wherein each sub-RIS of the plurality of sub-RISs comprises at least one RIS element of the plurality of RIS elements of the RIS.

In an embodiment of the disclosure, the measurement report comprises a Measure-Configuration Information Element having the RSRP for at least one of the direct BS candidate beam and the RIS candidate beam.

In an embodiment of the disclosure, the method comprises determining the RSRP criteria based on at least one of a position of the UE, the measurement report received from the U, a position of the RIS, a nature of beam blockage and a predefined threshold values of the RSRP.

In an embodiment of the disclosure, the method further comprises determining whether the RS is transmitted to the UE through one of a BS-RIS-UE link or a BS-UE link. The method further comprises, in case that the RS is transmitted to the UE through the BS-RIS-UE link, selecting at least one second mode configuration from the plurality of mode configurations for the RIS and sending a RS for at least one of the direct BS candidate beam and the RIS candidate beam to the UE using the at least one second mode configuration. The method further comprises, in case that the RS is transmitted to the UE through the BS-UE link, selecting the first mode configuration for the RIS.

In an embodiment of the disclosure, in case that the first mode configuration comprises randomly selected at least one of the phase shift and the amplitude of each RIS element of the plurality of RIS elements, at least one of the phase shift and the amplitude of at least one of the RIS element of the plurality of RIS elements of the RIS is adjusted based on the first mode configuration. And the multiple beams are scattered into the different directions based on at least one of adjusted phases shifts and the amplitudes of the at least one RIS element.

In an embodiment of the disclosure, in case that the first mode configuration comprises the total power of the RIS distributed among the plurality of the sub-RISs, the RIS is divided into the plurality of sub-RISs based on the first mode configuration. And the multiple beams are scattered into the different directions from each sub-RIS of the plurality of sub-RISs.

In an embodiment of the disclosure, the method performed by RIS controller is provided. The method comprises creating a first mode configuration to scatter the multiple beams from the RIS when the RIS is ide. The method further comprises storing the first mode configuration for the RIS among a plurality of mode configurations for the RIS. And the method further comprises configuring the first mode configuration to the RIS for scattering the multiple beams from the RIS in different directions.

In an embodiment of the disclosure, a bases station for wireless communication is provided. The base station comprises a memory, a processor coupled to the memory, a communicator coupled to the memory and the processor, and a beam scattering controller coupled to the memory, the processor, and the communicator. The processor is configured to transmit, to the UE a reference signal (RS) for at least one of a direct BS candidate beam and a RIS candidate beam. The processor is further configured to receive, from the UE, a measurement report comprising a Reference Signal Received Power (RSRP) measured by the UE for at least one of the direct BS candidate beam and the RIS candidate beam. The processor is further configured to determine whether the RSRP meets a RSRP criteria indicating the RIS is idle. The processor is further configured to, in case that the RSRT meets the RSRP criteria, select a first mode configuration for the RIS among a plurality of mode configurations for the RIS based on a link between the BS and the UE, wherein the first mode configuration is configured for scattering the multiple beams from the RIS. And the processor is further configured to switch from the RIS candidate beam to the direct BS candidate beam and scattering the multiple beams from the RIS in different directions.

1. A method performed by a base station (BS) comprising:
transmitting, to a user equipment (UE), a reference signal (RS) for at least one of a direct BS candidate beam and an reconfigurable intelligent surface (RIS) candidate beam;
receiving, from the UE, a measurement report comprising a reference signal received power (RSRP) measured by the UE for at least one of the direct BS candidate beam and the RIS candidate beam;
determining whether the RSRP meets a RSRP criteria indicating the RIS is idle;
in case that the RSRP meets the RSRP criteria:
selecting a first mode configuration for the RIS among a plurality of mode configurations for the RIS based on a link between the BS and the UE, wherein the first mode configuration is configured for scattering multiple beams from the RIS; and
switching from the RIS candidate beam to the direct BS candidate beam and scattering the multiple beams from the RIS in different directions.

2. The method of claim 1, wherein the first mode configuration comprises at least one of OFF mode configuration, scatter mode configuration, abort mode configuration or absorption mode configuration.

3. The method of claim 1, wherein the first mode configuration comprises at least one: randomly selected at least one of phase shift and amplitude of each RIS element of a plurality of RIS elements of the RIS, or a total power of the RIS distributed among a plurality of sub-RISs, wherein each sub-RIS of the plurality of sub-RISs comprises at least one RIS element of the plurality of RIS elements of the RIS.

4. The method of claim 1, the measurement report comprises a Measure-Configuration Information Element (IE) having the RSRP for at least one of the direct BS candidate beam and the RIS candidate beam.

5. The method of claim 1, wherein the method comprises determining the RSRP criteria based on at least one of a position of the UE, the measurement report received from the UE, a position of the RIS, a nature of beam blockage and predefined threshold values of the RSRP.

6. The method of claim 1, wherein selecting the first mode configuration for the RIS based on the link between the BS and the UE comprises:
determining whether the RS is transmitted to the UE through one of a BS-RIS-UE link or a BS-UE link;
in case that the RS is transmitted to the UE through the BS-RIS-UE link, selecting at least one second mode configuration from the plurality of mode configurations for the RIS, and sending an RS for at least one of the direct BS candidate beam and the RIS candidate beam to the UE using the at least one second mode configuration; and
in case that the RS is transmitted to the UE through the BS-UE link, selecting the first mode configuration for the RIS.

7. The method of claim 3, wherein in case that the first mode configuration comprises randomly selected at least one of the phase shift and the amplitude of each RIS element of the plurality of RIS elements,
at least one of the phase shift and the amplitude of at least one of the RIS element of the plurality of RIS elements of the RIS is adjusted based on the first mode configuration; and
the multiple beams are scattered into the different directions based on at least one of adjusted phase shifts and the amplitudes of the at least one RIS element.

8. The method of claim 3, wherein in case that the first mode configuration comprises the total power of the RIS distributed among the plurality of the sub-RISs
the RIS is divided into the plurality of sub-RISs based on the first mode configuration,
the total power of the RIS is allocated among the plurality of sub-RISs based on the first mode configuration, and
the multiple beams are scattered into the different directions from each sub-RIS of the plurality of sub-RISs.

9. A method performed by a reconfigurable intelligent surface (RIS) controller comprising:
creating a first mode configuration to scatter multiple beams from an RIS when the RIS is idle,
storing the first mode configuration for the RIS among a plurality of mode configurations for the RIS; and
configuring the first mode configuration to the RIS for scattering the multiple beams from the RIS in different directions.

10. The method of claim 9, wherein in case that the first mode configuration comprises randomly selected at least one of the phase shift and the amplitude of each RIS element of the plurality of RIS elements, the method comprises:
adjusting at least one of the phase shift and the amplitude of the at least one RIS element of the plurality of RIS elements of the RIS based on the first mode configuration, wherein the first mode configuration is at least one of an OFF mode configuration, a scatter mode configuration, an abort mode configuration and an absorption mode configuration; and
assisting the RIS to scatter the multiple beams into the different directions based on at least one of the adjusted phase shifts and the amplitudes of the at least one RIS element.

11. The method of claim 9, wherein in case that the first mode configuration comprises the total power of the RIS distributed among the plurality of the sub-RISs, the method comprises:
dividing the RIS into the plurality of sub-RISs based on the first mode configuration;
allocating the total power of the RIS among the plurality of sub-RISs based on the first mode configuration; and
assisting the RIS to scatter the multiple beams into the different directions from each sub-RIS of the plurality of sub-RISs.

12. A base station (BS) in a wireless communication system, the BS comprising:
a memory;
a processor coupled to the memory;
a communicator coupled to the memory and the processor; and
a beams scattering controller coupled to the memory, the processor and the communicator, and the processor is configured to:
transmit, to a user equipment (UE), a reference signal (RS) for at least one of a direct BS candidate beam and a reconfigurable intelligent surface (RIS) candidate beam;
receive, from the UE, a measurement report comprising a reference signal received power (RSRP) measured by the UE for at least one of the direct BS candidate beam and the RIS candidate beam;
determine whether the RSRP meets a RSRP criteria indicating the RIS is idle;
in case that the RSRP meets the RSRP criteria:
select a first mode configuration for the RIS among a plurality of mode configurations for the RIS based on a link between the BS and the UE, wherein the first mode configuration is configured for scattering multiple beams from the RIS; and
switch from the RIS candidate beam to the direct BS candidate beam and scatter the multiple beams from the RIS in different directions.

13. The BS of claim 12, wherein the first mode configuration comprises at least one of an OFF mode configuration, scatter mode configuration, abort mode configuration or absorption mode configuration.

14. The BS of claim 12, wherein the BS determines the RSRP criteria based on a position of the UE, the measurement report received from the UE, a position of the RIS, a past nature of beam blockage and predefined threshold values of the RSRP.

15. The BS of claim 12, wherein the first mode configuration comprises at least one: randomly selected at least one of phase shift and amplitude of each RIS element of a plurality of RIS elements of the RIS, or a total power of the RIS distributed among a plurality of sub-RISs, wherein each sub-RIS of the plurality of sub-RISs comprises at least one RIS element of the plurality of RIS elements of the RIS.
